(19) United States
(12) Patent Application Publication
(10) Pub. No.: US 2017/0109932 A1
(43) Pub. Date: Apr. 20, 2017

(54) CONTENT PROJECTION APPARATUS, CONTENT PROJECTION METHOD, AND COMPUTER READABLE STORAGE MEDIUM

(71) Applicant: FUJITSU LIMITED, Kawasaki-shi (JP)

(72) Inventors: Junya Fujimoto, Atsugi (JP); Keiju Okabayashi, Sagamihara (JP)

(73) Assignee: FUJITSU LIMITED, Kawasaki-shi (JP)

(21) Appl. No.: 15/292,420

(22) Filed: Oct. 13, 2016

(30) Foreign Application Priority Data
Oct. 16, 2015 (JP) 2015-205047

(51) Int. Cl. G06T 19/00; G09G 3/00

(52) U.S. Cl. CPC G06T 19/006; G09G 3/001; G09G 2340/04

(57) ABSTRACT

A content projection apparatus including: a memory, and a processor coupled to the memory and the processor configured to: obtain a range image of a space, detect a plane region in the range image of the space, determine an aspect ratio of each of a plurality of grids, into which the plane region is divided, based on a horizontal-to-vertical ratio of contents to be projected on the space, determine at least one specified grid whose distance from an outside of the plane region is the longest in the plurality of grids, and output information for projecting the contents in a position of one of the at least one specified grid of the space with a specified size that is determined based on the distance.

### CROSS-REFERENCE TO RELATED APPLICATION

This application is based upon and claims the benefit of priority of the prior Japanese Patent Application No. 2015-205047, filed on Oct. 16, 2015, the entire contents of which are incorporated herein by reference.

### FIELD

The embodiments discussed herein are related to a content projection apparatus, a content projection method, and a content projection program.

### BACKGROUND

Information may be presented according to an environment of a work-site or a situation of work in order to support various works in the work-site.

In a case where the presentation of information about a work is realized on a screen of a terminal device, an operator works while viewing a screen or operating a touch panel of a mobile terminal device such as a smartphone held in a hand. In such a case, since the device is operated by the hands during the work, the presentation of information may be one cause of impeding the progress of work.

The presentation of information may be realized by the projection of a content image, so-called projection artificial reality (AR). An effort is made to set the position and the size of the content image to be projected when the content image is projected. That is, if the setting is manually performed, an effort to perform the setting arises for each work-site. Furthermore, even if the position and the size in which the content image is projected are fixed, the position of an operator or the arrangement of facilities may not be said to be fixed. Thus, even if the content image is projected to the position determined by the setting, the displayed content image may not be identified in a case where the operator and the facilities act as an obstacle and block the optical path between a light-emitting portion of a projector and a projection plane.

Therefore, a method is desired that automatically calculates the position from which the image data of a content may be projected to a region falling within one plane so as to be as large as possible in size. One example of a suggested relevant technology is a projection apparatus for automatically changing a projection region according to an installation location. This projection apparatus sets a rectangle having the same aspect ratio as that of projected image at each vertex of a plane area having the same distance from the projector or at the center of the plane area. Then, the projection apparatus performs a process of enlarging each rectangle until the rectangles reach outside of the area, and performs projection to a rectangular region having the maximum area.

Japanese Laid-open Patent Publication No. 2014-192808 is an example of the related art.

### SUMMARY

According to an aspect of the invention, a content projection apparatus includes a memory, and a processor coupled to the memory and the processor configured to: obtain a range image of a space, detect a plane region in the range image of the space, determine an aspect ratio of each of a plurality of grids, into which the plane region is divided, based on a horizontal-to-vertical ratio of contents to be projected on the space, determine at least one specified grid whose distance from an outside of the plane region is the longest in the plurality of grids, and output information for projecting the contents in a position of one of the at least one specified grid of the space with a specified size that is determined based on the distance.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating one example of a system configuration of an information provision system according to a first embodiment;

FIG. 2 is a diagram illustrating one example of a scene in which projection AR is initiated;

FIG. 3 is a block diagram illustrating a functional configuration of a portable type information provision apparatus according to the first embodiment;

FIG. 4 is a diagram illustrating an example of failure of projection AR;

FIG. 5 is a diagram illustrating one example of the limitations of an existing technology;

FIG. 6 is a diagram illustrating one example of the limitations of an existing technology;

FIG. 7 is a diagram illustrating one example of the limitations of an existing technology;

FIG. 8 is a diagram illustrating one example of the limitations of an existing technology;

FIG. 9 is a diagram illustrating one example of a plane region;

FIG. 10 is a diagram illustrating one example of a bounding box;

FIG. 11 is a diagram illustrating one example of splitting into a grid;

FIG. 12 is a diagram illustrating one example of a grid outside of the plane region;

FIG. 13 is a diagram illustrating one example of a distance conversion result;

FIG. 14 is a diagram illustrating an example of content projection;

FIG. 15 is a diagram illustrating another example of splitting into a grid;

FIG. 16 is a flowchart illustrating a procedure of a content projection process according to the first embodiment;

FIG. 17 is a flowchart illustrating a procedure of a plane detection process according to the first embodiment;

FIG. 18 is a flowchart illustrating a procedure of a projection parameter calculation process according to the first embodiment;

FIG. 19 is a diagram illustrating one example of a content;

FIG. 20 is a diagram illustrating an example of the application of the shape of the grid; and

FIG. 21 is a diagram illustrating a hardware configuration example of a computer that executes a content projection program according to the first embodiment and a second embodiment.

### DESCRIPTION OF EMBODIMENTS

In the above technology, however, a rectangle may not be said to be typically set at the vertexes or the center of a plane area, and a rectangle may not be typically set according to the shape of the peripheral area of the vertexes or the center of a plane area. Thus, a content image (hereinafter also referred to simply as “content”) may not be projected in the maximum projected size.

An object of one aspect of embodiments is the provision of a content projection apparatus, a content projection method, and a content projection program that may project a content in the maximum projected size.

Hereinafter, a content projection apparatus, a content projection method, and a content projection program according to the present application will be described with reference to the appended drawings. The embodiments do not limit the technology disclosed. Each embodiment may be appropriately combined to the extent not contradicting the contents of processes.

### First Embodiment

### System Configuration

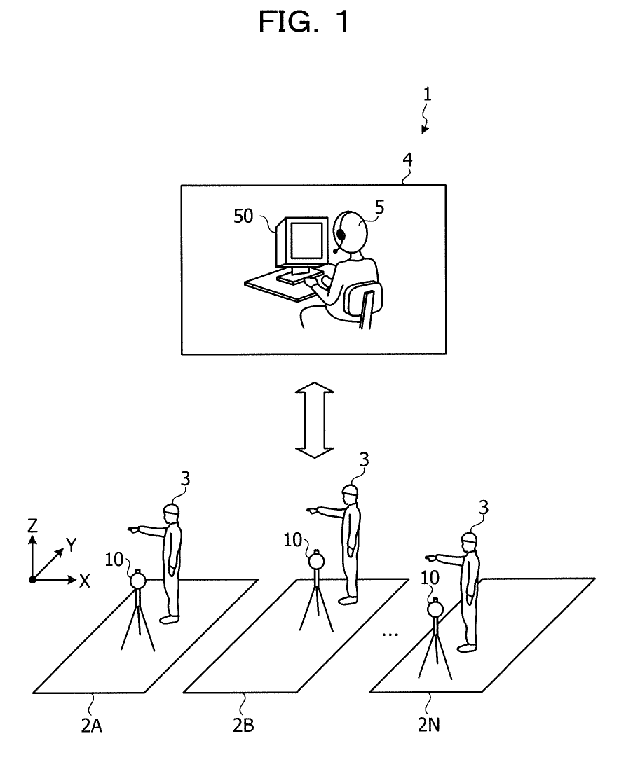

FIG. 1 is a diagram illustrating one example of a system configuration of an information provision system according to a first embodiment. FIG. 1 illustrates a work-site 2A to a work-site 2N as one example of a section in which work is performed. Furthermore, FIG. 1 illustrates a case where an operator 3 performs inspection work in the work-site 2A to the work-site 2N and where the work performed by the operator 3 is supported by a supporter 5 from a remote location 4 that is separate from the work-site 2A to the work-site 2N. Hereinafter, the work-site 2A to the work-site 2N may be described as a “work-site 2” if referred to collectively.

An information provision system 1 illustrated in FIG. 1 provides information provision service that provides the operator 3 with support data used for work in the work-site 2. The information provision service is realized by the projection of a content related to the support data, that is, projection AR, from the viewpoint of realizing hands-free work.

The information provision system 1, as a part of the information provision service, applies distance conversion to a grid of split bounding boxes of a plane region detected from 3D point group information and thereby assigns each grid element a distance to the outside of the plane region and realizes a content projection process that sets a grid element having the maximum distance as a projected position. Accordingly, as in a case of setting a rectangle having the same aspect ratio as the aspect ratio of the content at each vertex or the center of the plane region and enlarging the rectangle to the outside of the area, the limitation of the shape of the plane region in which the projected position of the content may be determined is avoided, and the content is projected in the maximum projected size.

As illustrated in FIG. 1, the information provision system 1 accommodates an information provision apparatus 10 and an information processing apparatus 50. While FIG. 1 illustratively illustrates one information provision apparatus 10 and one information processing apparatus 50, a plurality of the information processing apparatuses 50 may be provided for one information provision apparatus 10, or a plurality of the information provision apparatuses 10 may be provided for one information processing apparatus 50.

The information provision apparatus 10 and the information processing apparatus 50 are communicably connected to each other through a predetermined network. Any type of communication network, either wired or wireless one, such as the Internet, a local area network (LAN), and a virtual private network (VPN) may be employed as one example of the network. In addition, both apparatuses may be communicably connected by short-range wireless communication such as Bluetooth (registered trademark) low energy (BLE).

The information provision apparatus 10 is an apparatus that provides the operator 3 in the work-site 2 with a content related to the support data.

The information provision apparatus 10, as one embodiment, is implemented as a portable type apparatus that the operator 3 carries by hand. When, for example, the operator 3 performs work in the work-site 2A to the work-site 2N, one information provision apparatus 10 may be carried and used in each work-site 2 even if one information provision apparatus 10 is not installed for one work-site 2. That is, each time work is ended in the work-site 2, the operator 3 carries the information provision apparatus 10 to the subsequent work-site 2 by hand and places the information provision apparatus 10 in any position in the subsequent work-site 2 and thereby may receive the provision of the support data.

The information provision apparatus 10 here may sense the position in which the operator 3 exists in the work-site 2, through sensors that measure the existence of a human being or the environment in the work-site 2, for example, a 3D sensor and a 2D sensor described later.

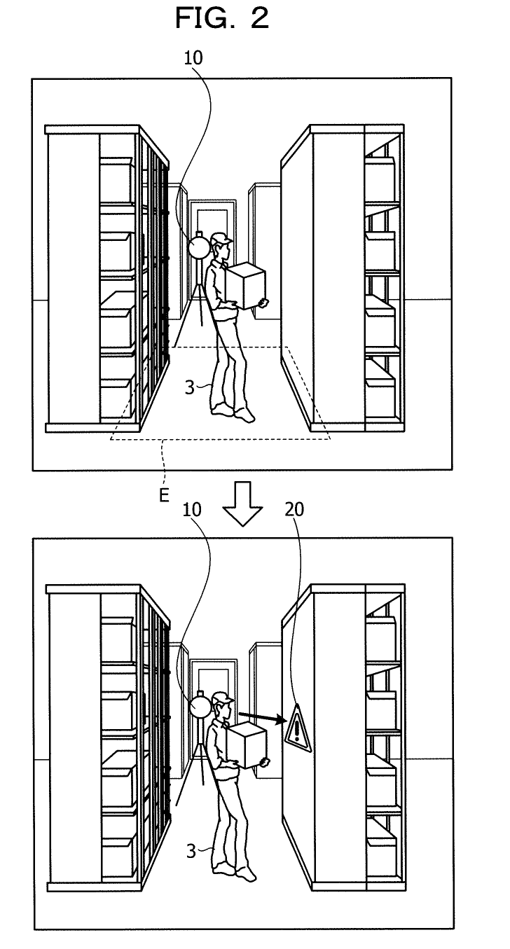

The information provision apparatus 10, for example, may initiate projection AR according to the position in which the operator 3 exists in the work-site 2. FIG. 2 is a diagram illustrating one example of a scene in which projection AR is initiated. As illustrated in FIG. 2, an area E in which the initiation of projection AR is defined is set in the work-site 2. The area E is correlated with a content 20 that is related to the support data. With the area E set, the information provision apparatus 10 estimates the position in which the operator 3 exists in the work-site 2, from 3D or 2D sensed data provided from the sensors. The information provision apparatus 10, in a case where the estimated position of the operator 3 is in the area E, initiates projection AR and projects the relevant content 20 to the area E.

In addition to the example illustrated in FIG. 2, the information provision apparatus 10 may initiate projection AR in cooperation with a wearable gadget that the operator 3 is equipped with. For example, the information provision apparatus 10 may sense a contact operation or an approaching operation of the operator 3 with respect to a predetermined facility such as an inspection target instrument (a meter, a valve, or the like) from sensed data that is output from a multiple range of wearable gadgets, such as a head-mounted display, an armlet type gadget, and a ring type gadget, and may initiate projection AR with the use of these operations as a trigger.

In addition to the use of the sensors, the information provision apparatus 10 may initiate projection AR with the use of time as a condition. For example, the information provision apparatus 10 may project a predetermined content at a predetermined time point with reference to schedule data in which a schedule of a content to be projected at a time point is associated with each time point.

The information processing apparatus 50 is a computer that is connected to the information provision apparatus 10.

The information processing apparatus 50, as one embodiment, is implemented as a personal computer that the supporter 5 uses in the remote location 4. The “remote location” referred hereto is not limited to a location of which the physical distance from the work-site 2 is long, and includes a location that is separate to the extent in which information may not be shared face-to-face with the work-site 2.

The information processing apparatus 50, for example, receives 3D and 2D sensed data from the information provision apparatus 10. Examples of sensed data sent from the information provision apparatus 10 to the information processing apparatus 50 may include a live image that is captured by a 3D sensor of the information provision apparatus 10. Displaying the live image on a predetermined display device or the like allows the supporter 5 to select the support data or generate the support data according to the state of the operator 3 or the environment in the work-site 2. Then, the information processing apparatus 50, in a case where an operation that instructs the information processing apparatus 50 to project the support data is received through an input device not illustrated, projects a content that is related to the support data and sent from the information processing apparatus 50 to the information provision apparatus 10, or projects a content, of contents stored in the information provision apparatus 10, that is specified from the information processing apparatus 50. As described, projection AR may be initiated in accordance with an instruction from the supporter 5.

### Portable Type Information Provision Apparatus 10

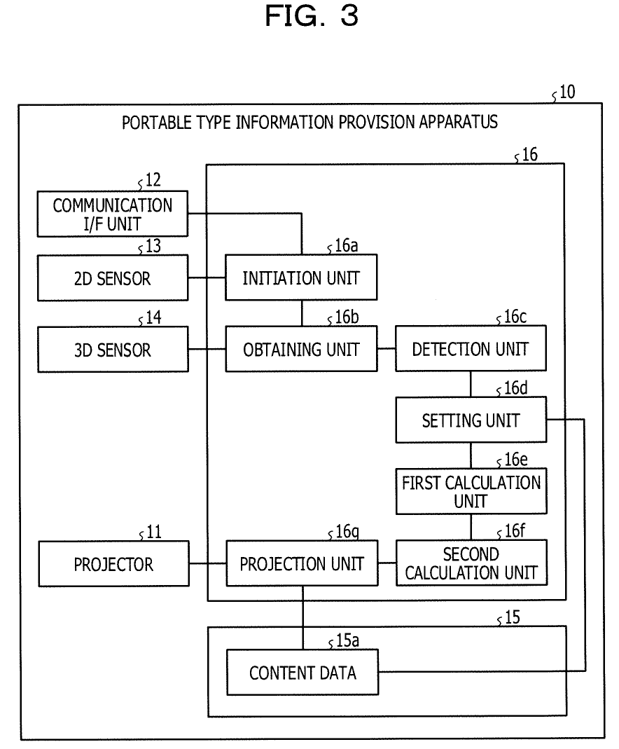

FIG. 3 is a block diagram illustrating a functional configuration of the portable type information provision apparatus 10 according to the first embodiment. As illustrated in FIG. 3, the portable type information provision apparatus 10 includes a projector 11, a communication interface (I/F) unit 12, a two dimensions (2D) sensor 13, a three dimensions (3D) sensor 14, a storage unit 15, and a control unit 16.

The projector 11 is a projector that projects an image in a space. The projector 11 may employ any type of display such as a liquid crystal type, a Digital Light Processing (DLP; registered trademark) type, a laser type, and a CRT type.

The communication I/F unit 12 is an interface that controls communication with other apparatuses, for example, the information processing apparatus 50.

The communication I/F unit 12, as one embodiment, may employ a network interface card such as a LAN card in a case where the communication network between the information provision apparatus 10 and the information processing apparatus 50 is connected by a LAN or the like. In addition, the communication I/F unit 12 may employ a BLE communication module in a case where the information provision apparatus 10 and the information processing apparatus 50 are connected by short-range wireless communication such as BLE. The communication I/F unit 12, for example, sends 3D and 2D sensed data to the information processing apparatus 50 and receives an instruction to display the support data from the information processing apparatus 50.

The 2D sensor 13 is a sensor that measures a two-dimensional distance.

The 2D sensor 13, as one embodiment, may employ a laser range finder (LRF), a millimeter wave radar, a laser radar, or the like. A distance on a horizontal plane, that is, an XY plane, with the information provision apparatus 10 set as the origin may be obtained by, for example, controlling the driving of a motor not illustrated to rotate the 2D sensor 13 in a horizontal direction, that is, about a Z axis. Two-dimensional omnidirectional distance information in the XY plane may be obtained as 2D sensed data by the 2D sensor 13.

The 3D sensor 14 is a three-dimensional scanner that outputs physical shape data of a space.

The 3D sensor 14, as one embodiment, may be implemented as a three-dimensional scanner that includes an infrared (IR) camera and an RGB camera. The IR camera and the RGB camera have the same resolution and share three-dimensional coordinates of a point group processed on a computer. For example, the RGB camera in the 3D sensor 14 captures a color image in synchronization with the IR camera that captures a range image by measuring the amount of time until infrared irradiation light returns after reflection by a target object in the environment. Accordingly, a distance (D) and color information (R, G, B) are obtained for each pixel corresponding to the angle of view of the 3D sensor 14, that is, each point (X, Y) corresponding to the resolution in a three-dimensional space. Hereinafter, a range image (X, Y, D) may be described as “3D point group information”. While capturing a range image and a color image is illustrated here, the content projection process uses at least a range image, and only a 3D distance camera may be implemented.

The storage unit 15 is a storage device that stores data used in various programs including an operating system (OS) executed by the control unit 16, the content projection program which realizes the content projection process, and the like.

The storage unit 15, as one embodiment, is implemented as a main storage device in the information provision apparatus 10. The storage unit 15, for example, may employ various semiconductor memory devices such as a random access memory (RAM) and a flash memory. In addition, the storage unit 15 may be implemented as an auxiliary storage device. In this case, a hard disk drive (HDD), an optical disc, a solid state drive (SSD), or the like may be employed.

The storage unit 15 stores content data 15a that is one example of data used in a program executed by the control unit 16. In addition to the content data 15a, other electronic data, such as schedule data in which a schedule of a content to be projected at a time point is associated with each time point, may be stored together.

The content data 15a is the data of a content related to the support data.

The content data 15a, as one embodiment, may employ data in which image data of a content to be projected by the projector 11 or identification information of the content is associated with sectioning information of an area in which the initiation of projection AR in the work-site 2 is defined. One example of a scene in which the content data 15a is referenced is a case where the initiation of projection AR is determined by whether or not the position of the operator 3 in the work-site 2 exists in any area. Another example is referencing the content data 15a in order to read a content corresponding to the area in which an entrance thereinto is sensed, that is, a content to be projected by the projector 11, in a case of initiating projection AR.

The control unit 16 includes an internal memory storing various programs and control data and performs various processes by using the programs and the control data.

The control unit 16, as one embodiment, is implemented as a central processing device, a so-called central processing unit (CPU). The control unit 16 may not be implemented as a central processing device and may be implemented as a micro processing unit (MPU). In addition, the control unit 16 may be realized by a hard-wired logic such as an application specific integrated circuit (ASIC) or a field programmable gate array (FPGA).

The control unit 16 virtually realizes the following processing units by executing various programs such as a preprocessor. For example, the control unit 16 includes an initiation unit 16a, an obtaining unit 16b, a detection unit 16c, a setting unit 16d, a first calculation unit 16e, a second calculation unit 16f, and a projection unit 16g as illustrated in FIG. 3.

The initiation unit 16a is a processing unit that initiates projection AR.

The initiation unit 16a, as one embodiment, determines whether or not to initiate projection AR by using sensors including the 2D sensor 13, the 3D sensor 14, a wearable gadget not illustrated, and the like. While initiating projection AR according to the position in which the operator 3 exists in the work-site 2 is illustratively illustrated here, projection AR may be initiated with the use of time as a condition, or projection AR may be initiated in accordance with an instruction from the information processing apparatus 50 as described above, in addition to the use of the sensors.

The initiation unit 16a, for example, estimates, from 3D sensed data obtained by the 3D sensor 14, the position in which the information provision apparatus 10 is placed in the work-site 2, and senses the presence of the operator 3 and the position of the operator 3 in the work-site 2 from 2D sensed data obtained by the 2D sensor 13.

Specifically, the shape around the waist of the operator 3 is highly likely to appear in the 2D sensed data in a case where the 2D sensor 13 is implemented in a position approximately 1 m above the surface on which the information provision apparatus 10 is placed. The 2D sensed data here is illustratively obtained as data in which the distance from the 2D sensor 13 to the target object is associated with each angle of rotation of the motor that rotationally drives the 2D sensor 13 in the horizontal direction, that is, about the Z axis. Thus, a change that matches the shape of the waist of the operator 3 appears in the distance that is plotted in accordance with a change in the angle of rotation, in a case where the operator 3 exists in a standing position in the peripheral area of the information provision apparatus 10. Therefore, the initiation unit 16a may sense the presence of a human being by determining whether or not a distance plot having similarity greater than or equal to a predetermined threshold to a predetermined template, such as waist shapes set for each gender, each age group, or each direction of the waist with respect to the 2D sensor 13, exists in the 2D sensed data. At this point, from the viewpoint of avoiding erroneous sensing caused by noise from an object such as a mannequin that has features similar to the shape of the waist of a human being, noise may be removed by whether or not there is a difference between the 2D sensed data at the time point of obtainment and the 2D sensed data at a previous time point such as one time point before. For example, the initiation unit 16a, in a case where a distance plot similar to the shape of the waist of a human being exists in the 2D sensed data, determines whether or not there is a change in the contour of a plot and in the position of the centroid of a figure formed by a distance plot on the XY plane, between a distance plot sensed from the 2D data and a distance plot sensed from the 2D sensed data one time point before. The initiation unit 16a may sense that the operator 3 exists in the work-site 2 by narrowing down to a case where there is a change in one or more of the position of the centroid and the contour of a plot.

Then, the initiation unit 16a, in a case where the operator 3 exists in the work-site, specifies the position of the operator 3 in the work-site 2 from the position of the information provision apparatus 10 in the work-site 2 estimated from the 3D sensed data and from the distance sensed from the 2D sensed data, that is, the distance from the information provision apparatus 10 to the operator 3. Then, the initiation unit 16a determines whether or not the position of the operator 3 in the work-site 2 exists in any area included in the content data 15a stored in the storage unit 15. At this point, the initiation unit 16a, in a case where the position of the operator 3 exists in any area, initiates projection AR for the content associated with the area.

The obtaining unit 16b is a processing unit that obtains the 3D point group information.

The obtaining unit 16b, as one embodiment, controls the 3D sensor 14 to obtain the 3D point group information in a case where projection AR is initiated by the initiation unit 16a. Here, 3D sensed data obtained by observing 360° in the horizontal direction is illustratively assumed to be obtained by controlling the driving of the motor not illustrated to drive the 3D sensor 14 to pan in the horizontal direction, that is, about the Z axis in a three-dimensional coordinate system illustrated in FIG. 1.

When, for example, 3D sensing is initiated, the obtaining unit 16b causes the 3D sensor 14 to capture a range image and a color image and thereby obtains the range image and the color image. Next, the obtaining unit 16b drives the 3D sensor 14 to pan about the Z axis at a predetermined angle, for example, 60° in the example of the angle of view of the present example. Then, the obtaining unit 16b obtains a range image and a color image in a new visual field after the pan drive. Then, the obtaining unit 16b repeats the pan drive and obtains a range image and a color image until omnidirectional, that is, 360°, range images and color images in the horizontal direction are obtained, by performing the pan drive a predetermined number of times, for example, five times in the example of the angle of view of the present example. When omnidirectional range images and color images in the horizontal direction are obtained, the obtaining unit 16b combines the range images and the color images obtained six times and thereby generates 3D sensed data, a so-called point cloud (X, Y, D, R, G, B). While a coordinate system of the 3D sensed data illustratively employs a three-dimensional coordinate system with the information provision apparatus 10 set as the origin, the coordinate system is not limited thereto. That is, the origin of the three-dimensional coordinate system may be set to any position, and the three-dimensional coordinate system may be converted into a global coordinate system by any technique such as map matching with a map of the work-site 2 or associating the three-dimensional coordinate system with an AR marker on the work-site 2.

The range image of the obtained 3D sensed data, that is, the 3D point group information (X, Y, D), is used in determining the projected position and the projected size of the content in a rear stage processing unit. While obtaining the omnidirectional 3D point group information in the horizontal direction is illustratively illustrated here, the 3D point group information may be obtained by narrowing down to a section in a case where an outline of the section to which the content is to be projected is determined.

The detection unit 16c is a processing unit that detects a plane region of the work-site 2 from the 3D point group information.

The detection unit 16c, as one embodiment, detects a plane region that is formed by a 3D point group included in the 3D point group information obtained by the obtaining unit 16b, in accordance with an algorithm such as random sample consensus (RANSAC). For example, the detection unit 16c obtains a 3D point group included in the 3D point group information as a sample and randomly extracts three points from the sample. Next, the detection unit 16c further extracts, from the 3D point group included in the 3D point group information, a point group that resides within a predetermined distance from a plane model determined by the three points randomly extracted from the sample. The processes below will be described while the point group residing within the predetermined distance from the plane model is regarded as a point group existing on the plane model. Then, the detection unit 16c determines whether or not the number of point groups existing on the plane model is greater than or equal to a predetermined threshold. At this point, the detection unit 16c, in a case where the number of point groups on the plane model is greater than or equal to the threshold, retains, in a work area on the internal memory, plane region data in which a parameter that defines the plane model, such as the coordinates of the three points or the equation of the plane, is associated with a point group included in the plane model. Meanwhile, the detection unit 16c does not retain the plane region data related to the plane model in a case where the number of point groups existing on the plane model is less than the threshold. Then, the detection unit 16c repeats the random sampling of three points from the sample and subsequently retains the plane region data for a predetermined times. This plane detection method allows obtaining of a plane model in which a certain number of point groups or more reside within a certain distance in the direction normal to the plane model. Hereinafter, a part in which a 3D point group exists at a predetermined density or higher on the plane defined by the plane model may be described as a “plane region”.

While retaining the plane region data on condition that the number of point groups existing on the plane model is greater than or equal to the threshold is illustrated here, the plane region data may be retained by narrowing down to a plane model in which the number of point groups existing on the plane model is equal to the maximum value.

The setting unit 16d is a processing unit that sets a grid size in which a bounding box set from a point group existing on the plane model is split.

The setting unit 16d, as one embodiment, selects one plane region of plane regions retained in the work area of the internal memory. Next, the setting unit 16d references the plane region data corresponding to the selected plane region and projects a 3D point group existing on the plane model to a two-dimensional projection plane, for example, the XY plane, and thereby converts the 3D point group into a 2D point group. The setting unit 16d calculates the bounding box for the 2D point group projected to the XY plane, a so-called circumscribed rectangle. Then, the setting unit 16d references the content data 15a stored in the storage unit 15 and obtains the horizontal-to-vertical ratio, the “aspect ratio” in the case of a rectangle, of the content associated with the area in which the operator 3 exists. Then, the setting unit 16d sets a grid size in which the horizontal size and the vertical size of the grid are sufficiently smaller than the size of the content to be projected and that has the same horizontal-to-vertical ratio as the horizontal-to-vertical ratio of the content. For example, the horizontal size and the vertical size of a grid are set to a size that has a certain level of visibility even if a place which may be projected onto the plane region includes only one grid, in other words, a size that is the smallest size in which the grid is seen. While using the horizontal-to-vertical ratio of a content in the setting of the grid size is illustratively illustrated here from the viewpoint of enlarging an image content with the horizontal-to-vertical ratio maintained, the horizontal-to-vertical ratio of the grid size is not limited thereto, and the length of each edge of the grid may be the same.

The first calculation unit 16e is a processing unit that calculates the projected position of the content.

The first calculation unit 16e, as one embodiment, splits the bounding box for the 2D point group into a grid in accordance with the grid size set by the setting unit 16d. Hereinafter, an element that is obtained by splitting the bounding box into a grid may be described as a “grid element”. The first calculation unit 16e calculates the number of points of the 2D point group included in the grid element for each grid element split from the bounding box. Next, the first calculation unit 16e assigns identification information such as a flag to the grid element, among grid elements, in which the number of points of the 2D point group is less than or equal to a predetermined value, for example, zero. That is, the fact that a grid element does not include any 2D point group means that the grid element is a grid element positioned outside of the plane region and not in the plane region, and the grid element outside of the plane region is assigned a marker in order to be identified from a grid element in the plane region. Then, the first calculation unit 16e applies distance conversion to the grid into which the bounding box is split, and thereby assigns each grid element the distance from the grid element to a grid element adjacent to the grid element outside of the plane region. The distance assigned to the grid element is the distance between grid elements, and for example, the number of movements in a case of moving along the shortest path from a target grid element to be assigned a distance to a grid element adjacent to the grid element outside of the plane region is assigned as a distance given that the distance from a focused grid element to each grid element adjacent to the focused grid element in eight directions including the horizontal, vertical, and inclined directions is equal to “1”. Then, the first calculation unit 16e calculates, as a projected position, a grid element of which the distance assigned by the distance conversion is the maximum. For example, the first calculation unit 16e sets the position in the three-dimensional space corresponding to the grid element having the maximum distance as the position to which the center of figure, for example, the center or the centroid, of the bounding box for the content is projected.

As described, the first calculation unit 16e uses the distance between grid elements assigned by the distance conversion as one example of an evaluated value to which a higher value is assigned as the grid element is more separate from the plane region, and evaluates which grid element appropriately corresponds to the center of figure of the bounding box for the content.

The second calculation unit 16f is a processing unit that calculates the projected size of the content.

The second calculation unit 16f, as one embodiment, calculates, as a projected size, the maximum size allowed for the projection of the content onto the plane region in a projected position in a case where a projected position related to the bounding box for the content is set by the first calculation unit 16e.

The second calculation unit 16f, as one aspect, sets a starting point to the grid element set in the projected position in a case where the horizontal-to-vertical ratio of the grid size is set to 1:1, and counts the number of grid elements from the starting point to a grid element adjacent to the grid element outside of the plane region in each of four directions including the upward, downward, leftward, and rightward directions of the grid element in the projected position. Then, the second calculation unit 16f divides, by the width of the content, the width corresponding to the total value of the number of grid elements until a rightward direction search from the starting point reaches the right end of the plane region and the number of grid elements until a leftward direction search from the starting point reaches the left end of the plane region, and sets the division result as a magnification by which the image data of the content is enlarged in the width direction, that is, the X direction. In addition, the second calculation unit 16f divides, by the height of the content, the height corresponding to the total value of the number of grid elements until an upward direction search from the starting point reaches the upper end of the plane region and the number of grid elements until a downward direction search from the starting point reaches the lower end of the plane region, and sets the division result as a magnification by which the image data of the content is enlarged in the height direction, that is, the Y direction.

As another aspect, the evaluated value assigned to the grid element in the projected position is directly linked to the size in which the distance may be projected onto the plane region in the present example, in a case where the horizontal-to-vertical ratio of the grid size is set to the same horizontal-to-vertical ratio as the horizontal-to-vertical ratio of the bounding box for the content. That is, if projection is performed to a size of 2×grid size×(evaluated value of the grid element in the projected position−0.5), the image data of the content, even if enlarged, falls within the plane region. Thus, the second calculation unit 16f sets the projected size of the image data of the content to 2×grid size×(evaluated value of the grid element in the projected position−0.5).

The projection unit 16g is a processing unit that controls projection performed by the projector 11.

The projection unit 16g, as one embodiment, reads the content data 15a, of the content data 15a stored in the storage unit 15, that is associated with the area in which the operator 3 exists. Next, the projection unit 16g causes the position in the three-dimensional space corresponding to the grid element calculated as a projected position by the first calculation unit 16e to match the center of figure of the bounding box for the content and causes the projector 11 to control the image data of the content to be enlarged to the projected size calculated by the second calculation unit 16f.

### Specific Example

Hereinafter, a specific example of the content of a process performed by the portable type information provision apparatus 10 according to the present embodiment will be described. An example of failure of projection AR will be described, and then the limitations of an existing technology will be described. With the example of failure and the limitations, one aspect of a problem to be solved by the portable type information provision apparatus 10 will be illustrated, and then a specific example of the content of a process performed by the portable type information provision apparatus 10 will be illustrated.

(1) Example of Failure of Projection AR

The visibility of a content, in a case of performing projection AR, is degraded with an inappropriate projected position even if the projected size is appropriate, or the visibility of a content is degraded with an inappropriate projected size even if the projected position is appropriate.

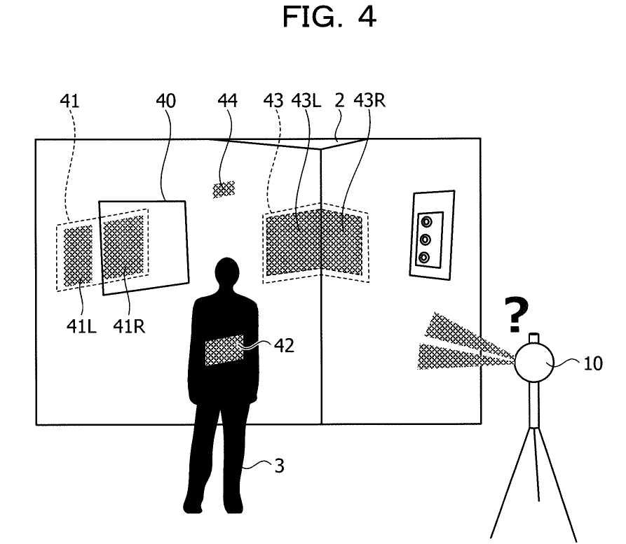

FIG. 4 is a diagram illustrating an example of failure of projection AR. In the case of a content 41 illustrated in FIG. 4, a difference in level between a panel 40 installed in the work-site 2 and a wall of the work-site 2 causes projection to be performed in a state where a left portion 41L of the content 41 and a right portion 41R of the content 41 are at different levels. In this case, the visibility of the part having different levels on the left and right sides is significantly degraded. In addition, in the case of a content 42 illustrated in FIG. 4, the operator 3 acts as an obstacle and blocks the optical path from a light-emitting portion of the projector to the projection plane, and consequently, the content is projected onto the operator 3. In this case, the visibility of the content is degraded by the colors or the shapes of clothes of the operator 3. Furthermore, in the case of a content 43 illustrated in FIG. 4, projection is performed in a state where there is a great angular difference between the projection plane of a left portion 43L of the content 43 and the projection plane of a right portion 43R of the content 43 due to a corner of a room in the work-site 2. In this case, the visibility of the part in which the left and right projection planes intersect with each other is significantly degraded.

As illustrated by the contents 41, 42, and 43, when the projected position of the content may not be appropriately set, simply reducing the projected size of the content may not be appropriate. That is, as illustrated by a content 44 illustrated in FIG. 4, visibility is apparently degraded if the projected size is excessively reduced compared with the contents 41, 42, and 43. Therefore, a technology that determines the position in which the content may be projected as largely as possible in a size falling within one plane is said to have high utility.

(2) Limitations of Existing Technology

Like a projection apparatus described in BACKGROUND, there exists a technology that determines, by the aspect ratio of projected image data, which plane area of plane areas having the same distance from a projector is to be set as a projection range. However, the projected size of the content to be projected onto the plane area depends on the shape of the plane area in the projection apparatus. The reason is that the algorithm of the projection apparatus that determines the projected position of the content has a defect.

That is, in a case of determining the projected position of the content in the existing technology, a rectangle that has the same aspect ratio as the aspect ratio of the projected image data is set at each vertex or the centroid of the plane area, and then a process of enlarging each rectangle until the rectangle reaches outside of the area is performed, and projection is performed to a rectangular region having the maximum area. However, even if a rectangle is set at each vertex or the centroid of the plane area, an appropriate projection region may not be searched for in a case where the plane area has the following shapes.

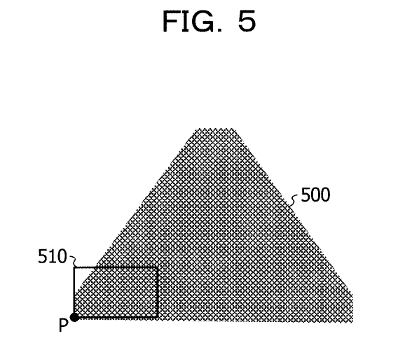

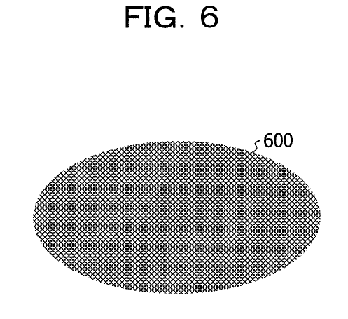

Searching for an appropriate projection region from a plane area 500 illustrated in FIG. 5 or a plane area 600 illustrated in FIG. 6 is difficult in a case where, for example, the rectangle is enlarged from a vertex of the plane area. FIG. 5 and FIG. 6 are diagrams illustrating one example of the limitations of the existing technology. FIG. 5 illustrates an example in which the area of the rectangle set at a vertex P of the plane area 500 is increased with the aspect ratio maintained. The plane area 500 has a shape that is broadly close to the shape of an equilateral triangle though the shape locally has a vertex of a straight angle or an obtuse angle, that is, a shape in which parts near the vertexes of an equilateral triangle are removed. When a rectangle set at a vertex is enlarged in a case where an area has a shape that is narrowed near the vertex like the plane area 500, the rectangle immediately reaches outside of the area like a rectangle 510 illustrated in FIG. 5. In addition, a rectangle may not be set in a case where an area has an elliptic shape surrounded by a smooth curve like the plane area 600 illustrated in FIG. 6, since there exists no vertex at all.

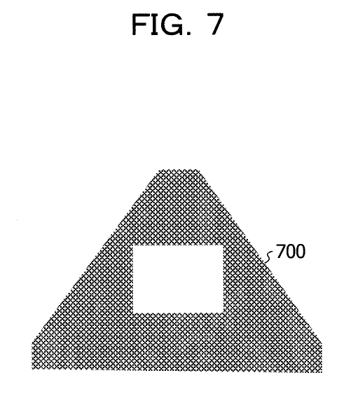

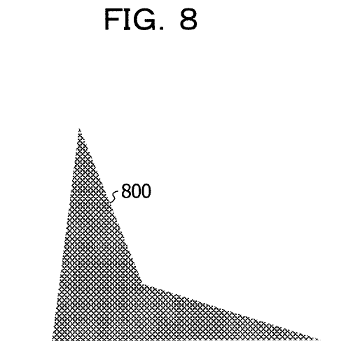

Searching for an appropriate projection region from a plane area 700 illustrated in FIG. 7 or a plane area 800 illustrated in FIG. 8 is difficult in a case where the rectangle is enlarged from the centroid of the plane area. FIG. 7 and FIG. 8 are diagrams illustrating one example of the limitations of the existing technology. FIG. 7 illustrates the plane area 700 in which the region around the centroid is determined to be outside of the plane area due to the shape around the centroid of the plane area 700 that is a protruding shape or a recessed shape. In the case of the plane area 700 illustrated in FIG. 7, since the centroid is outside of the plane area, the content may not be projected to the plane even if a rectangle is set at the centroid. FIG. 8 illustrates the plane area 800 that is a concave polygon. In the case of the plane area 800 illustrated in FIG. 8, since the centroid is outside of or near the plane area as in the case of the plane area 700 illustrated in FIG. 7, the content may not be projected to the plane even if a rectangle is set at the centroid.

(3) Content of Process of Information Provision Apparatus 10

Therefore, the information provision apparatus 10 applies distance conversion to a grid of split bounding boxes of a plane region detected from 3D point group information and thereby assigns each grid element a distance to the outside of the plane region and realizes a content projection process that sets a grid element having the maximum distance as a projected position.

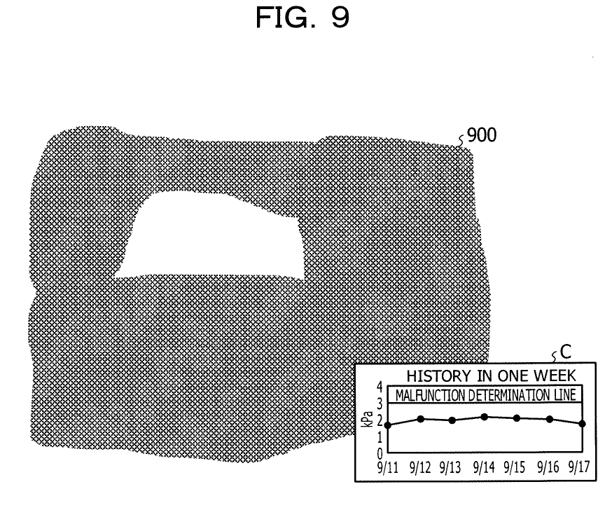

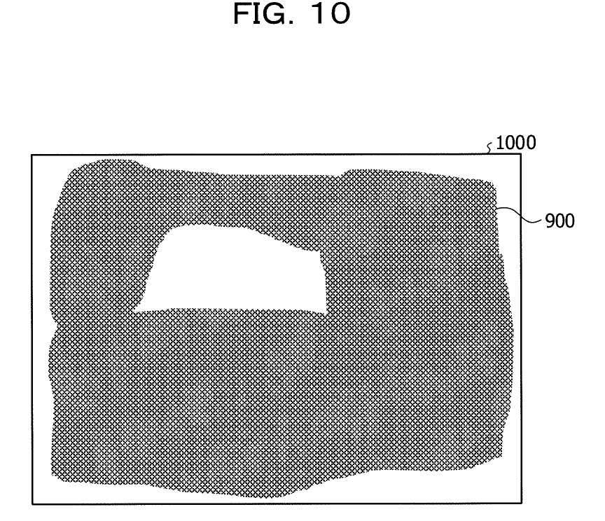

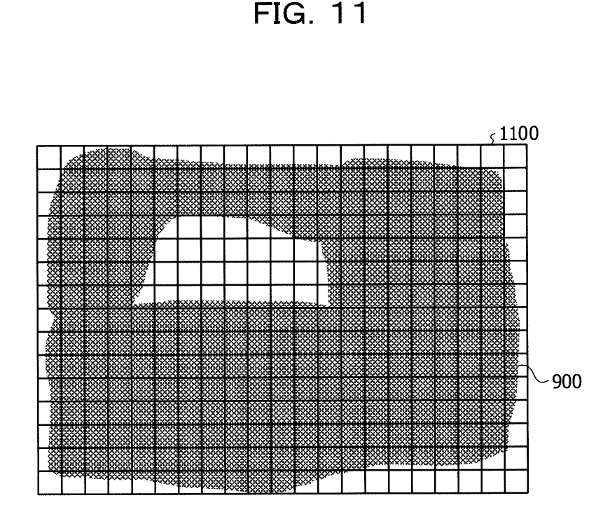

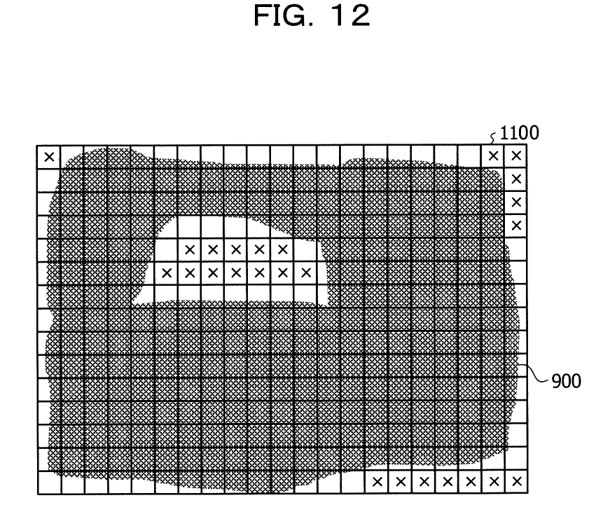

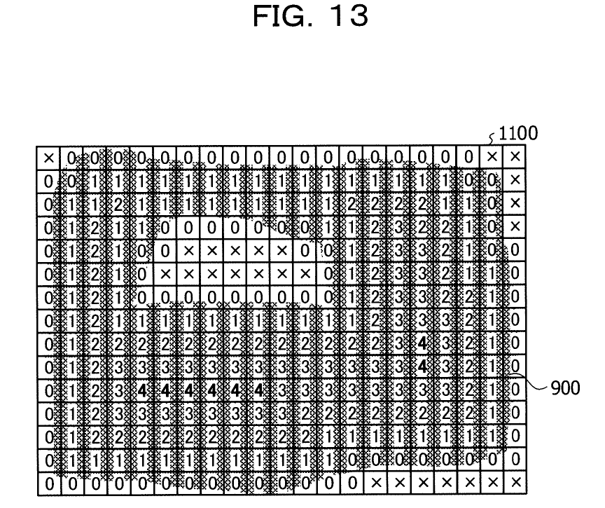

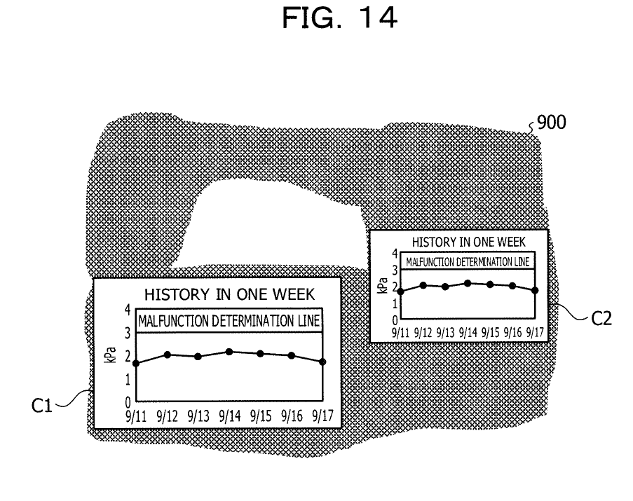

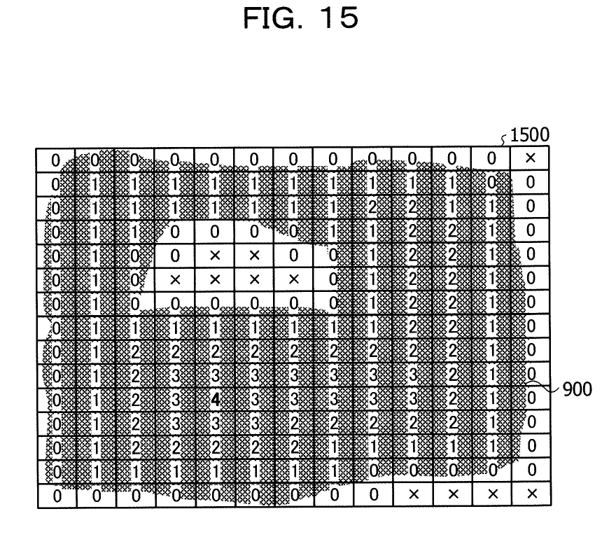

The content projection process will be specifically described by using FIG. 9 to FIG. 15. FIG. 9 is a diagram illustrating one example of a plane region. FIG. 10 is a diagram illustrating one example of a bounding box. FIG. 11 is a diagram illustrating one example of splitting into a grid. FIG. 12 is a diagram illustrating one example of a grid outside of the plane region. FIG. 13 is a diagram illustrating one example of a distance conversion result. FIG. 14 is a diagram illustrating an example of content projection. FIG. 15 is a diagram illustrating another example of splitting into a grid.

FIG. 9 illustrates a plane region 900 that is detected from the 3D point group information (X, Y, D). In the plane region 900, a 3D point group that exists at a predetermined density or higher on a plane model defined by three points randomly sampled in accordance with an algorithm such as RANSAC is projected to a two-dimensional plane, the XY plane, and turns into a 2D point group, and the 2D point group is illustrated as a filled region for convenience of description.

The content of a process performed in a case where the image of support data related to the history of pressure of an instrument such as a drainpipe is projected to the plane region 900 as a content C will be illustratively described here. The content C allows the operator 3 to determine whether or not the pressure of the drainpipe or the like is normal, that is, whether to open or close a valve of the drainpipe, and furthermore, the degree of opening or closing of the drainpipe in a case where the pressure of the drainpipe is in the vicinity of a malfunction determination line or in a case where the pressure exceeds the malfunction determination line.

As illustrated in FIG. 10, a bounding box 1000 for the 2D point group included in the plane region 900 is calculated in the plane region 900 illustrated in FIG. 9. With the bounding box 1000 set, the bounding box 1000 for the 2D point group is split into a grid in accordance with a predetermined grid size as illustrated in FIG. 11. Accordingly, a set of grid elements 1100 into which the bounding box 1000 is split is obtained. FIG. 11 illustratively illustrates performing splitting into a grid in accordance with the setting of a grid size such that the length of each edge of the grid is the same.

Then, the number of points of the 2D point group included in a grid element is calculated for each grid element. At this point, a grid element, among grid elements, for which the number of points of the 2D point group is equal to “0” is assigned identification information such as a flag. For example, in the example illustrated in FIG. 12, a grid element that does not include any point of the 2D point group is illustrated with a mark “×” in order to be identified from a grid element in the plane region.

Distance conversion is applied to the set of grid elements 1100 into which the bounding box 1000 is split, in a state where grid elements outside of the plane region are identifiable, and thereby each grid element is assigned the distance from the grid element to a grid element adjacent to the grid element outside of the plane region as illustrated in FIG. 13. For example, the grid element in the first row and the first column, that is, (1, 1), is outside of the plane region. Thus, a distance “0” is assigned to the grid elements (1, 2), (2, 2), and (2, 1) that are adjacent to the grid element (1, 1). In addition, the grid element (2, 3) is at the shortest distance from the grid elements (1, 2), (1, 3), (1, 4), and (2, 2) that are adjacent to the grid element outside of the plane region. Since all of these grid elements are separate by one from the grid element (2, 3), the grid element (2, 3) is assigned a distance “1”.

The maximum distance value is equal to “4” in a case where the distance conversion is performed. The maximum distance value “4” appears in a plurality of grid elements in the example of FIG. 13. In this case, any grid element of the plurality of grid elements is set as a projected position. For example, a content C1 illustrated in FIG. 14 is projected to the plane region 900 in a case where any grid element of the grid elements in which six of the distance “4” are continuous in the horizontal direction is set as a projected position. In addition, a content C2 illustrated in FIG. 14 is projected to the plane region 900 in a case where any grid element of the grid elements in which two of the distance “4” are continuous in the vertical direction is set as a projected position.

As described, the information provision apparatus 10 according to the present embodiment applies distance conversion to a grid of split bounding boxes of a plane region detected from 3D point group information and thereby assigns each grid element a distance to the outside of the plane region and realizes a content projection process that sets a grid element having the maximum distance as a projected position. Thus, even if the shape around the vertex or the centroid of the plane region is one of the shapes illustrated in FIG. 5 to FIG. 8, the projected position of a content may be determined, and thus the limitation of the shape of the plane region in which the projected position of a content may be determined may be avoided. Therefore, a content may be projected in the maximum projected size.

A content is vertically long or horizontally long and does not have the same vertical and horizontal sizes, like the content C illustrated in FIG. 9, in a case where a grid size having the same length of each edge of the grid is set as illustrated in FIG. 11. Thus, as one aspect, a problem arises in that the magnitude of the evaluated value obtained by distance conversion is not directly linked to a size in which projection may be performed. Thus, setting a grid element having a small evaluated value as a projected position may allow projection to be performed largely in a case where a content image is remarkably long vertically or horizontally.

(4) Example of Application of Splitting into Grid

As an additional study for avoiding such a problem, the ratio of the horizontal to vertical sizes of a grid element may be set to the ratio of the horizontal to vertical sizes of the bounding box for a content when splitting into a grid is performed. For example, applying distance conversion in the same manner as the case illustrated in FIG. 13 to the grid of which the grid size is set to have the same horizontal-to-vertical ratio as the horizontal-to-vertical ratio of the content C illustrated in FIG. 9 allows evaluation of a space considering the shape of the content C like a grid 1500 illustrated in FIG. 15, and consequently the evaluated value may be directly linked to a size in which projection may be performed. That is, if projection is performed to a size of 2×grid size×(evaluated value of the grid element in the projected position−0.5), the image data of the content C, even if enlarged, may fall within the plane region 900. As described, the possibility that a projected position in which projection may be performed in a large projected size is determined may be higher in a case of applying the splitting into a grid illustrated in FIG. 15 than in a case of applying the splitting into a grid illustrated in FIG. 9.

### Flow of Process

Next, the flow of a process of the information provision apparatus 10 according to the present embodiment will be described. Here, (1) a content projection process performed by the information provision apparatus 10 will be described, and then (2) a plane detection process and (3) a projection parameter calculation process that are performed as a sub-flow of the content projection process will be described.

(1) Content Projection Process

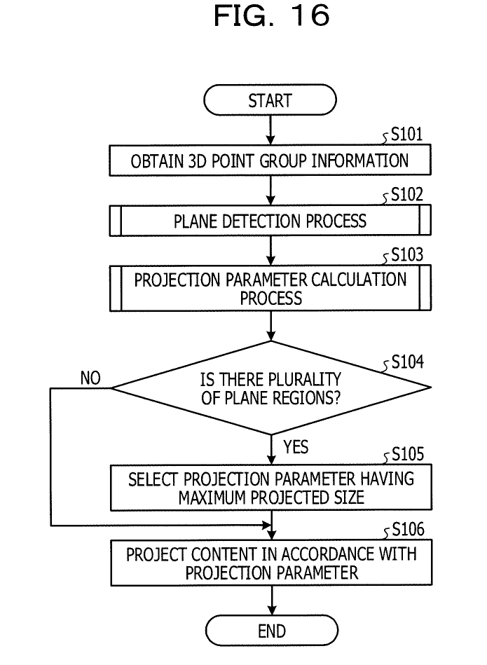

FIG. 16 is a flowchart illustrating a procedure of the content projection process according to the first embodiment. This process is illustratively started in a case where projection AR is initiated by the initiation unit 16a.

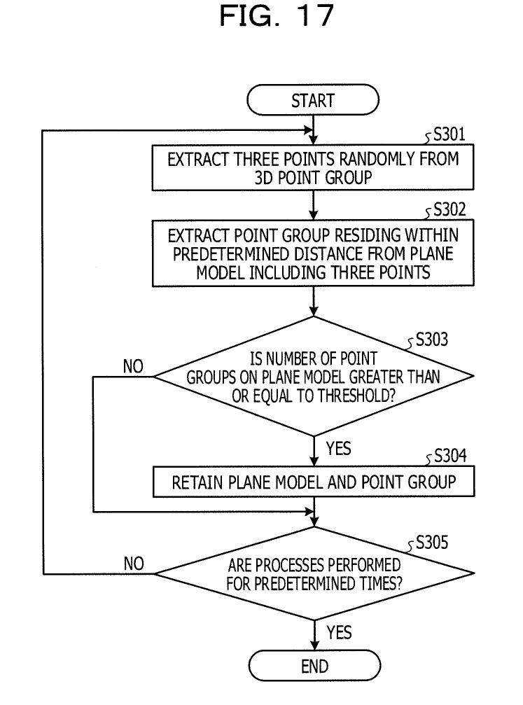

As illustrated in FIG. 16, the obtaining unit 16b controls the 3D sensor 14 to obtain 3D point group information (Step S101). Then, the detection unit 16c, as described later by using FIG. 17, performs a “plane detection process” that detects a plane region formed by a 3D point group included in the 3D point group information obtained in Step S101 in accordance with an algorithm such as RANSAC (Step S102).

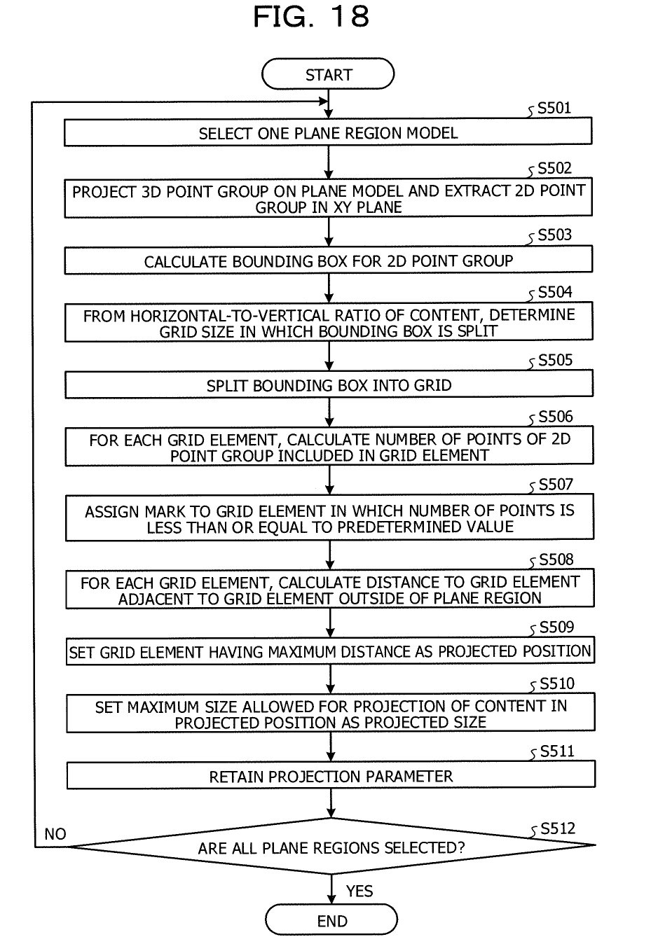

Next, the setting unit 16d, the first calculation unit 16e, and the second calculation unit 16f, as described later by using FIG. 18, perform a “projection parameter calculation process” that calculates, for each plane region detected in Step S102, projection parameters including a projected position and a projected size in a case of projecting a content to the plane region (Step S103).

The projection unit 16g, in a case where a plurality of plane regions is detected in Step S102 (Yes in Step S104), selects a projection parameter having the maximum projected size from the projection parameters calculated for each plane region in Step S103 (Step S105). The projection parameter is unambiguously determined in a case where only one plane region is detected in Step S102 (No in Step S104), and thus the process of Step S105 may be skipped.

Then, the projection unit 16g projects the image data of the content that is stored as the content data 15a in the storage unit 13, in accordance with the projection parameter selected in Step S105 (Step S106) and ends the process.

(2) Plane Detection Process

FIG. 17 is a flowchart illustrating a procedure of the plane detection process according to the first embodiment. This process corresponds to the process of Step S102 illustrated in FIG. 16 and is started in a case where 3D point group information is obtained in Step S101.

As illustrated in FIG. 17, the detection unit 16c obtains a 3D point group included in the 3D point group information obtained in Step S101 as a sample and randomly extracts three points from the sample (Step S301).

Next, the detection unit 16c further extracts, from the 3D point group included in the 3D point group information, a point group that resides within a predetermined distance from a plane model determined by the three point randomly extracted in Step S301 (Step S302).

Then, the detection unit 16c determines whether or not the number of point groups existing on the plane model is greater than or equal to a predetermined threshold (Step S303). At this point, the detection unit 16c, in a case where the number of point groups on the plane model is greater than or equal to the threshold (Yes in Step S303), retains, in the work area on the internal memory, plane region data in which a parameter that defines the plane model, such as the coordinates of the three points or the equation of the plane, is associated with a point group included in the plane model (Step S304). Meanwhile, the plane region data related to the plane model is not retained in a case where the number of point groups existing on the plane model is less than the threshold (No in Step S303).

Then, the detection unit 16c repeats the processes of Step S301 to Step S304 until the processes of Step S301 to Step S304 are performed for predetermined times (No in Step S305). The process is ended in a case where the processes of Step S301 to Step S304 are performed for predetermined times (Yes in Step S305).

(3) Projection Parameter Calculation Process

FIG. 18 is a flowchart illustrating a procedure of the projection parameter calculation process according to the first embodiment. This process corresponds to the process of Step S103 illustrated in FIG. 16 and is performed after the plane detection process described in Step S102 is performed.

As illustrated in FIG. 18, the setting unit 16d selects one plane region from the plane regions that are retained in the work area of the internal memory in Step S304 illustrated in FIG. 17 (Step S501).

Next, the setting unit 16d references the plane region data corresponding to the plane region selected in Step S501 and projects a 3D point group existing on the plane model to a two-dimensional projection plane, for example, the XY plane, and thereby converts the 3D point group into a 2D point group (Step S502).

The setting unit 16d calculates the bounding box for the 2D point group that is projected on the XY plane in Step S502 (Step S503). Then, the setting unit 16d references the content data, of the content data 15a stored in the storage unit 15, that is associated with the area in which the operator 3 exists, and sets a grid size in which the horizontal size and the vertical size of the grid are sufficiently smaller than the size of the content subjected to projection and that has the same horizontal-to-vertical ratio as the horizontal-to-vertical ratio of the content (Step S504).

Next, the first calculation unit 16e splits the bounding box for the 2D point group obtained in Step S503 into a grid in accordance with the grid size set in Step S504 (Step S505).

The first calculation unit 16e calculates the number of points of the 2D point group included in the grid element for each grid element split from the bounding box in Step S505 (Step S506). Next, the first calculation unit 16e assigns identification information such as a flag to the grid element, among grid elements, in which the number of points of the 2D point group is less than or equal to a predetermined value, for example, zero (Step S507).

Then, the first calculation unit 16e applies distance conversion to the grid into which the bounding box is split, and thereby assigns each grid element the distance from the grid element to a grid element adjacent to the grid element outside of the plane region (Step S508).

Then, the first calculation unit 16e calculates, as the position to which the center of figure, for example, the center or the centroid, of the bounding box for the content is projected, the position in the three-dimensional space corresponding to the grid element that has the maximum distance assigned by distance conversion in Step S508 (Step S509).

Furthermore, the second calculation unit 16f, in a case where the projected position related to the bounding box for the content is set in Step S509, calculates, as a projected size, the maximum size allowed for the projection of the content onto the plane region in the projected position (Step S510).

Then, the projection unit 16g retains, in the internal memory, the projected position calculated in Step S509 and the projected size calculated in Step S510 as the projection parameter of the plane region selected in Step S501 (Step S511).

The processes of Step S501 to Step S511 are repeated until all plane regions retained in the work area of the internal memory in Step S304 illustrated in FIG. 17 are selected (No in Step S512). Then, the process is ended in a case where all plane regions retained in the work area of the internal memory in Step S304 illustrated in FIG. 17 are selected (Yes in Step S512).

### One Aspect of Effect

As described heretofore, the information provision apparatus 10 according to the present embodiment applies distance conversion to a grid of split bounding boxes of a plane region detected from 3D point group information and thereby assigns each grid element a distance to the outside of the plane region and realizes a content projection process that sets a grid element having the maximum distance as a projected position. Thus, the limitation of the shape of a plane region in which the projected position of a content may be determined may be avoided. Therefore, the information provision apparatus 10 according to the present embodiment may project a content in the maximum projected size.

### Second Embodiment

While an embodiment related to the disclosed apparatus is described heretofore, embodiments may be implemented in various different forms in addition to the above embodiment. Therefore, hereinafter, another embodiment included in the embodiments will be described.

### Example of Application of Projected Position Calculation

While the first embodiment is illustrated in a case where a grid element having the maximum distance assigned by distance conversion is calculated as a projected position, more than one grid element may have the maximum distance. In this case, selecting any grid element allows projection to be performed in a certain projected size. However, the projected size of a content may be different according to the selected grid element. Therefore, performing a process described below in a case where there exists a plurality of grid elements having the maximum distance allows a grid element that may be projected in the maximum projected size to be selected from the plurality of grid elements.

The first calculation unit 16e, for example, in a case where there exists a plurality of grid elements having the maximum distance, applies various filters to the grid that is assigned with distances by distance conversion, and performs a filter convolution operation. A smoothing filter or a Gaussian filter, for example, for which the filter coefficient of a focused pixel is greater than the filter coefficient of a non-focused pixel may be applied as the filter.

The first calculation unit 16e determines whether or not the grid elements having the maximum distance are narrowed down to one by the filter convolution operation. The first calculation unit 16e, in a case where the grid elements having the maximum distance are narrowed down to one, calculates, as a projected position, the grid element that is narrowed down by the filter convolution operation. Then, the filter convolution operation is repeated for predetermined times until the grid elements having the maximum distance are narrowed down to one. The first calculation unit 16e, in a case where the grid elements having the maximum distance are consequently not narrowed down to one even after the predetermined times, randomly selects one grid element from the grid elements having the maximum distance.

Narrowing the grid elements having the maximum distance down to one by repeating the filter convolution operation allows a grid element, of the plurality of grid elements, that may be projected in the maximum projected size to be set as a projected position.

### Shape of Grid

While the shape of the grid is illustratively illustrated as a rectangle in the first embodiment, the shape of the grid is not limited to a rectangle. For example, the shape of the grid into which the bounding box is split may be a parallelogram in the information provision apparatus 10.

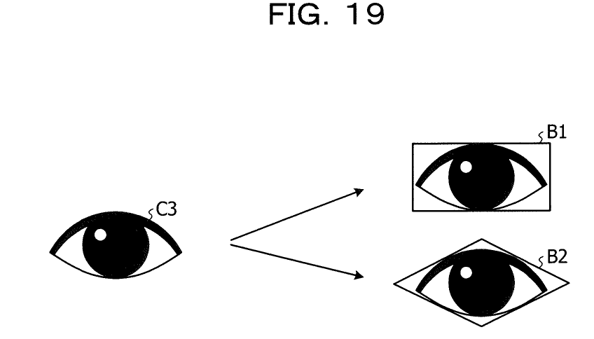

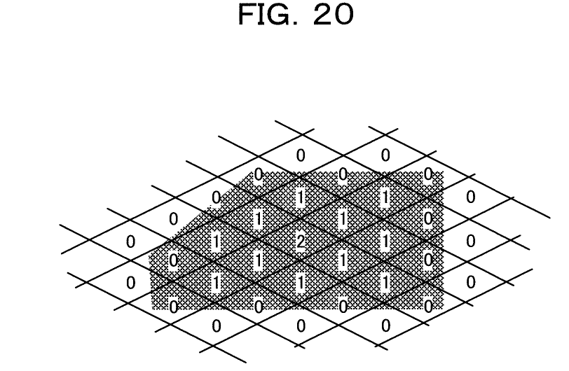

FIG. 19 is a diagram illustrating one example of a content. FIG. 20 is a diagram illustrating an example of the application of the shape of the grid. In the case of a content C3 illustrated in FIG. 19, the shape of the bounding box that circumscribes the content C3 is more appropriately a parallelogram than a rectangle. When a rectangular bounding box B1 is calculated, split into rectangular grid elements, and subjected to distance conversion in a case of calculating a projection parameter of the content C3, it is considered that there occurs a case where the projected position in which projection may be performed in the maximum projected size may not be determined. Therefore, a parallelogramic bounding box B2 is further calculated from the 2D point group along with the rectangular bounding box B1, and splitting into a grid is performed for each of the two bounding boxes. Then, the total number of grid elements outside of the plane region is compared for each type of the rectangular and parallelogramic bounding boxes, a grid type for which the total number of grid elements outside of the plane region is small is selected, and the processes after distance conversion may be performed. In this case, the processes of Step S508 to Step S511, as illustrated in FIG. 20, may be apparently applied in the same manner to a case where the parallelogramic grid is selected.

Accordingly, splitting in a grid shape that further fits the shape of the content may obtain a larger position and a larger size in which projection may be performed, than simply splitting in a rectangle having the aspect ratio of the bounding box for the content.

### Example of Application of Plane Region

While the first embodiment is illustrated in a case where a projection parameter is calculated from the entire plane region detected by the detection unit 16c, a partial region of the plane region may be excluded from the plane region. That is, it may be desirable to project a content away from a poster in cases where a poster is bonded to a plain wall in the work-site 2. In such a case, referencing color information, for example, (X, Y, R, G, B), in addition to the distance (X, Y, D) obtained by the 3D sensor 14 allows a partial region to be excluded from the plane region and regarded as the outside of the plane region. For example, the information provision apparatus 10 references the color information (X, Y, R, G, B) corresponding to the point group in the plane region, performs a labeling process in the plane region for each region formed in the same color, and determines the presence of a shape for each region assigned the same label. The information provision apparatus 10 identifies a region in which a shape does not exist as the “inside of the plane region” and, meanwhile, identifies a region in which a shape exists as the “outside of the plane region”. Accordingly, a content may be projected by excluding a non-plain region of the plane region, for example, the region in which the poster or the like is displayed or a specific mark exists. Furthermore, the information provision apparatus 10 may identify a monochrome region in which a shape does not exist as the “inside of the plane region”. Accordingly, a content may be projected by narrowing down to a more wall-like region.

### Another Implementation Example

While the first embodiment illustrates a content projection apparatus as the information provision apparatus 10, the form of the implementation of the information provision apparatus 10 is not limited thereto. For example, since the number of mobile terminal devices equipped with a 3D measuring function or a projection function is on an increasing trend, a general-purpose mobile terminal device or the like may be implemented as the information provision apparatus 10. In this case, the content projection process may be performed by implementing process units such as the initiation unit 16a, the obtaining unit 16b, the detection unit 16c, the setting unit 16d, the first calculation unit 16e, the second calculation unit 16f, and the projection unit 16g in the mobile terminal device. While the first embodiment is illustrated in a case where 3D point group information is obtained from a 3D distance camera, 3D point group information may not be obtained from a 3D distance camera. For example, a range image corresponding to 3D point group information may be calculated from the disparity of a stereo image that is captured by two or more cameras.

### Distribution and Integration

Each constituent element of each apparatus illustrated may not be physically configured as illustrated. That is, a specific form of distribution or integration of each apparatus is not limited to the illustrations, and a part or the entirety thereof may be configured to be functionally or physically distributed or integrated in any units according to various loads, the status of usage, and the like. For example, the initiation unit 16a, the obtaining unit 16b, the detection unit 16c, the setting unit 16d, the first calculation unit 16e, the second calculation unit 16f, or the projection unit 16g may be connected as an external device to the information provision apparatus 10 via a network. In addition, each different apparatus may include the initiation unit 16a, the obtaining unit 16b, the detection unit 16c, the setting unit 16d, the first calculation unit 16e, the second calculation unit 16f, or the projection unit 16g, be connected to a network, and cooperate with each other to realize the function of the information provision apparatus 10. In addition, each different apparatus may include a part or the entirety of data stored in the storage unit 15, for example, the content data 15a, be connected to a network, and cooperate with each other to realize the function of the information provision apparatus 10.

### Content Projection Program

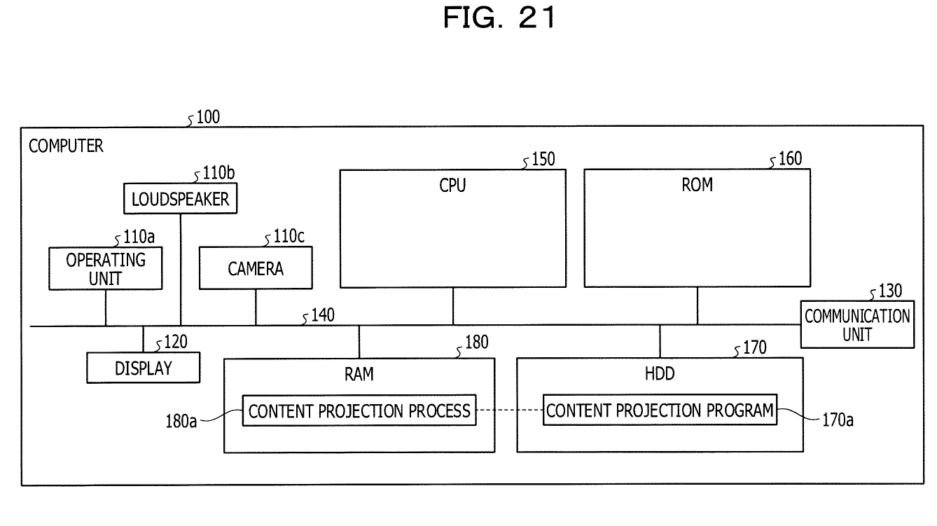

Various processes described in the embodiments may be realized by a computer such as a personal computer or a workstation executing a program that is prepared in advance. Therefore, hereinafter, one example of a computer that executes a content projection program having the same function as the embodiments will be described by using FIG. 21.

FIG. 21 is a diagram illustrating a hardware configuration example of a computer that executes a content projection program according to the first embodiment and the second embodiment. As illustrated in FIG. 21, a computer 100 includes an operating unit 110a, a loudspeaker 110b, a camera 110c, a display 120, and a communication unit 130. Furthermore, the computer 100 includes a CPU 150, a ROM 160, an HDD 170, and a RAM 180. These units 110 to 180 are connected to each other through a bus 140.

The HDD 170 stores, as illustrated in FIG. 21, a content projection program 170a that exhibits the same function as the initiation unit 16a, the obtaining unit 16b, the detection unit 16c, the setting unit 16d, the first calculation unit 16e, the second calculation unit 16f, and the projection unit 16g illustrated in the first embodiment. The content projection program 170a may be integrated or distributed in the same manner as each constituent element of the initiation unit 16a, the obtaining unit 16b, the detection unit 16c, the setting unit 16d, the first calculation unit 16e, the second calculation unit 16f, and the projection unit 16g illustrated in FIG. 3. That is, the HDD 170 may not store all of the data illustrated in the first embodiment provided that the data used in processing is stored in the HDD 170.

In this environment, the CPU 150 reads the content projection program 170a from the HDD 170 and loads the content projection program 170a into the RAM 180. Consequently, the content projection program 170a functions as a content projection process 180a as illustrated in FIG. 21. The content projection process 180a loads various types of data read from the HDD 170 into a region, in a storage region included in the RAM 180, that is assigned to the content projection process 180a, and performs various processes using the loaded various types of data. Examples of the processes performed by the content projection process 180a include, for example, the processes illustrated in FIG. 16 to FIG. 18. Not all of the processing units illustrated in the first embodiment may be operated by the CPU 150 provided that a processing unit corresponding to a target process is virtually realized.

The content projection program 170a may not be initially stored in the HDD 170 or the ROM 160. For example, the content projection program 170a is stored in a “portable physical medium” that is inserted into the computer 100, such as a flexible disk, a so-called FD, a CD-ROM, a DVD disc, a magneto-optical disc, and an IC card. The computer 100 may obtain and execute the content projection program 170a from the portable physical medium. The content projection program 170a may be stored in another computer or a server apparatus that is connected to the computer 100 through a public line, the Internet, a LAN, a WAN, and the like, and the computer 100 may obtain and execute the content projection program 170a from the other computer or the server apparatus.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A content projection apparatus comprising:
a memory; and
a processor coupled to the memory and the processor configured to:
obtain a range image of a space,
detect a plane region in the range image of the space,
determine an aspect ratio of each of a plurality of grids, into which the plane region is divided, based on a horizontal-to-vertical ratio of contents to be projected on the space,
determine at least one specified grid whose distance from an outside of the plane region is the longest in the plurality of grids, and
output information for projecting the contents in a position of one of the at least one specified grid of the space with a specified size that is determined based on the distance.

2. The content projection apparatus according to claim 1, wherein
the processor is configured to determine, when the at least one specified grid includes a plurality of specified grids, the one of the at least one specified grid by repeating a convolution operation of a specified filter that is applied to the at least one specified grid.

3. The content projection apparatus according to claim 1, wherein
the processor is configured to extract a plain region from the plane region to be divided into the plurality of grids.

4. A content projection method comprising:
obtaining a range image of a space;
detecting a plane region in the range image of the space;
determining an aspect ratio of each of a plurality of grids, into which the plane region is divided, based on a horizontal-to-vertical ratio of contents to be projected on the space;
determining at least one specified grid whose distance from an outside of the plane region is the longest in the plurality of grids; and
outputting information for projecting the contents in a position of one of the at least one specified grid of the space with a specified size that is determined based on the distance.

5. A non-transitory computer readable storage medium that stores a program that causes a computer to execute a process comprising:
obtaining a range image of a space;
detecting a plane region in the range image of the space;
determining an aspect ratio of each of a plurality of grids, into which the plane region is divided, based on a horizontal-to-vertical ratio of contents to be projected on the space;
determining at least one specified grid whose distance from an outside of the plane region is the longest in the plurality of grids; and
outputting information for projecting the contents in a position of one of the at least one specified grid of the space with a specified size that is determined based on the distance.
